(19) United States
(12) Patent Application Publication
(10) Pub. No.: US 2009/0066238 A1
(43) Pub. Date: Mar. 12, 2009

(54) Electroluminescent materials grafted with charge transport moieties having graded ionization potential or electrophilic property and their application in light-emitting diodes

(75) Inventors: Show-An Chen, Hsinchu (TW); Chih-Wei Huang, Hsinchu (TW); Kang-Yung Peng, Hsinchu (TW); Ching-Yang Liu, Hsinchu (TW)

Correspondence Address: BACON & THOMAS, PLLC, 625 SLATERS LANE, FOURTH FLOOR, ALEXANDRIA, VA, 22314-1176, US

(73) Assignee: National Tsing Hua University, Hsinchu (TW)

(21) Appl. No.: 12/230,725

(22) Filed: Sep. 4, 2008

(30) Foreign Application Priority Data
Sep. 6, 2007 (TW) 96133232

(51) Int. Cl. H01J 1/63; C08L 83/10; C08F 289/00

(52) U.S. Cl. 313/504; 525/474; 525/540

(57) ABSTRACT

This invention provides new electroluminescent materials such as a conjugated polymer or a phosphorescent organometallic complex, which are grafted with multiple charge transport moieties with graded ionization potential or electrophilic property. The charge transport moieties can be all hole transport moieties or all electron transport moieties. The emissive electroluminescent materials covering the full visible range can be prepared. Organic light emitting diodes prepared with these materials can be used as indicators, light source and display for cellular phones, digital camera, pager, portable computer, personal data acquisition (PDA), watch, hand-held videogame, and billboard, etc.

### FIELD OF THE INVENTION

The present invention relates to novel electroluminescent materials such as a conjugated polymer or a phosphorescent organometallic complex, which are grafted with multiple charge transport moieties with graded ionization potential or electrophilic property. The charge transport moieties can be all hole transport moieties or all electron transport moieties. Organic light emitting diodes prepared with these materials can be used as indicators, light source and display for cellular phones, digital camera, pager, portable computer, personal data acquisition (PDA), watch, hand-held videogame, and billboard, etc.

### BACKGROUND OF THE INVENTION

In 1987, Tang, C. W et al (Appl. Phys. Lett., 51, 913 (2007)) reported an organic light-emitting diodes having a structure of ITO/Diamine/AlQ₃/Mg:Ag by evaporation of organic and metals, wherein ITO is a transparent conductive material, AlQ₃ is tris(8-hydroxyquinoline) aluminum as both electron transport and emissive material. This device has an external quantum efficiency of 1% and brightness of 1000 cd/m² at 10V, which motivates a rapid development in the research of organic light emitting diodes. In 1990, Friend, R. H. et al. from the Carvendish laboratory in England made a polymer light emitting diode with a structure of ITO/PPV/Ca, wherein PPV is a conjugated polymer, poly(p-phenylene vinylene). This device gives an external quantum efficiency of 0.05% and emits yellowish green light (Nature, 347, 539 (1990)). It indicates the beginning of solution processable polymer light emitting diodes. Developing high performance materials is of key importance of high performance PLEDs. Currently, two classes of emitting materials are been developed, namely conjugated polymers and small molecule dopants. For the former, to date, polyfluorene derivatives were thorough investigated because of their high fluorescent quantum efficiencies and being blue emitting materials [Ohmiori, Y. et al, Jpn. J. Appl. Phys., 30, 1941 (1991). Pei, Q er al, J. Am. Chem. Soc., 118, 7416 (1996). Wu, W. L. et al Appl. Phys. Lett., 75, 3270 (1999). Yu, W. L. et al. Adv. Mater., 12, 828 (2000). Setayesh, S. et al. J. Am. Chem. Soc., 123, 946 (2001). Pogantsch, A. et al. Adv. Mater., 14, 1061 (2002); Nakazawa, Y K. et al. Appl. Phys. Lett., 80, 3832 (2002). Wu, Y. et al. Org. Lett., 6,3485 (2004)]. After this, introducing single charge transporting materials (by blending or attaching to polymer structure directly) to elevate the efficiencies of organic light emitting devices were carried out [Liu, M. S. et al. Chem. Mater., 13, 3820 (2001). Ding, J. et al. Macromolecules, 35, 3474 (2002). Wu, F. I. et al. Chem. Mater., 15, 269 (2003). Sainova, D. et al. Appl. Phys. Lett., 76, 1810 (2000). Miteva, T. et al. Adv. Mater. 13, 565 (2001). Ego, et al. Adv. Mater. 14, 809 (2002). Chen, X. et al. J. Am. Chem. Soc. 125, 636 (2003). Muller, C. D. et al. Nature, 421, 829 (2003)]. Interfacial engineering approaches were also applied to promote the efficiencies of blue emitting devices [Grice, A. W. et al. Appl. Phys. Lett., 73, 629 (1998). Jiang, X. et al. Appl. Phys. Lett., 76, 1813 (2000). Yan, H. et al. Adv. Mater. 15, 835 (2003)]. For the later, orgnometallic emitters have attracted much attention since they can harvest both singlet and triplet excitons to achieve high performance. Of these, Ir complexes have been investigated thoroughly as phosphorescent emitters due to their high efficiencies and tunable emission colors over the whole visible region by modifications of ligands [S. Lamsky et al. J. Am. Chem. Soc. 123, 4304 (2001). S. Lamsky et al. Inorg. Chem. 40, 1704 (2001).] Soon after this finding, research activities have also been directed to development of electophosphorescent polymers to allow solution processability and low-cost large area display fabrication, among which the highest performance “green” emitting phosphorescent device gives the external quantum efficiencies (EQEs) 11.8% and luminous efficiency 38 lm/W by using the alternative copolymer bearing triphenyl diamine (TPD), 2-(4-biphenylyl)-5-(4-tert-butylphenyl)-1,3,4-oxadiazole (PBD) with a green light-emitting Ir-phosphor as side groups [M. Suzuki et all. Appl. Phys. Lett. 86, 103507 (2005)]. Recently Nakamura et al. reported a single layer electrophosphorescent device, having the emitting layer composed of poly(vinylcarbazole) (PVK) as the host, 1,3-bis(4-tert-butylphenyl-1,3,4-oxadiazoyl)phenylene (OXD-7) as the electron-transporting material, and soluble derivative of bis[2-(2,4-difluorophenyl)pyridinyl]picolinate iridium (Firpic) as blue dopant along with Cs as the cathode; the efficiency was 14 cd/A (EQE ca. 7%) though its turn-on voltage was not given [A. Nakamura et al. Appl. Phys. Lett. 84, 130 (2004).]. Further efforts have been attempted by promoting balance of charge transport via either adjusting content of OXD-7 (reaching EQE ca. 9%) [M. K. Mathai et al. Appl. Phys. Lett. 88, 243512 (2006). X. H. Yang et al. Appl. Phys. Lett. 88,021107 (2006).] or incorporating additional hole-transporting layers (11.5 cd/A, EQE 5.7%) [X. Yang et al. Adv. Mater. 18, 948 (2006).]. Also design of the iridium dendrimers has been attempted. For example, a fac-tris[2-(2,4-difluorophenyl)pyridyl]iridium type dendrimer based device were fabricated to give the device efficiency 10.4% and 11 lm/W though the luminance was not given and it required an additional hole-blocking layer [S. C. Lo et al. Adv, Func. Mater. 15, 51 2005].].

Despite the recent developments stated above, the efficiencies of polymer blue-light-emitting devices are still lower than the green and red emission SM counterparts. The plausible reasons are the presence of high barrier for hole injection and difficulty in charge trapping from host to dopant (due to the energy level mismatching between host and dopant). To diminish the hole injection barrier, Friend and coworkers proposed that the graded electronic profile (in which HOMO levels can be divided into several descent levels) can be established by interfacial engineering approach. The efficiencies of the devices can be further improved (Peter, H. K. H. et al. Nature 404, 481 (2000)). However, the approach of interfacial engineering to realize graded electronic profile require complicate fabrication processes and serious inaccuracy may occurred during these procedures. Balancing charge fluxes by incorporating charge transporting moieties and simplified fabrication process (no need for additional transporting layer) are essential to design LEDs. Thus, it is highly desirable to develop electroluminescent materials which can utilize graded electronic profile (descent energy levels) in single molecule and simplified fabrication process of LEDs.

One of the inventors of the present application and his co-workers in U.S. Pat. Nos. 7,098,295 B2 and 7,220,819 B2 disclose an electroluminescent conjugated polymer comprises a side chain comprising a phosphorescent organometallic complex, and optionally further comprises another side chain comprising a charge transport moiety, details of which are incorporated herein by reference.

### SUMMARY OF THE INVENTION

A primary objective of the present invention is to provide an electroluminescent material, which is able to use graded energy levels to render its HOMO energy levels in a gradually decreasing trend.

Another objective of the present invention is to provide a novel electroluminescent material, which is able to facilitate the fabrication of light emitting diodes.

In order to accomplish the above objectives an electroluminescent material provided according to the present invention are grafted with multiple charge transport moieties with graded ionization potential or electrophilic property.

Preferably, the electroluminescent material is a conjugated polymer grafted with said multiple charge transport moieties.

Preferably, said conjugated polymer has a backbone comprising one or more repeating unit selected from the group consisting of mono-, bicycle- and polycyclic aromatic groups; heterocyclic aromatic group; substituted aromatic group; and substituted heterocyclic group.

Preferably, said conjugated polymer further comprises a side chain comprising a phosphorescent moiety.

Preferably, one of said multiple charge transport moieties is covalently linked to the backbone of the conjugated polymer through a spacer selected from the group consisting of an alkylene, an alkylene containing heteroatoms, a substituted alkylene, a substituted alkylene containing heteroatoms, an aromatic group, a heterocyclic aromatic group, a substituted aromatic group, a substituted heterocyclic aromatic group, and a combination thereof. More preferably, said spacer comprises hexylene or decylene.

Preferably, said charge transport moieties are hole transport moieties, wherein said hole transport moieties are independently selected from the group consisting of a tertiary arylamine, a quarternary arylammonium salt, a tertiary heterocyclic aromatic amine, a quarternary heterocyclic aromatic ammonium, a substituted tertiary arylamine, a substituted quarternary arylammonium salt, a substituted heterocyclic aromatic amine, and a substituted quarternary heterocyclic aromatic ammonium.

Preferably, said charge transport moieties are electron transport moieties, wherein said electron transport moieties independently comprise an oxadiazole, thiodiazole, triazole, pyridine, or pyrimidine group and are independently selected from the group consisting of a monoheterocyclic aromatic group, biheterocyclic aromatic group and polyheterocyclic aromatic group.

Preferably, said conjugated polymer is a random copolymer, block copolymer or alternating copolymer. More preferably, said conjugated polymer comprises a non-conjugated sector among two or more conjugated sectors in a backbone of said copolymer.

Preferably, said conjugated polymer is a homopolymer.

Preferably, said backbone of said conjugated polymer comprises a repeating unit of fluorene or benzene.

Preferably, said charge transport moieties are hole transport moieties, said backbone of said conjugated polymer comprises two different repeating units, each of which comprises a side chain, each side chain comprising a hole transport moiety, wherein said two hole transport moieties are different. More preferably, said two different hole transport moieties are carbazole and triphenylamine.

Preferably, said charge transport moieties are electron transport moieties, said backbone of said conjugated polymer comprises two different repeating units, each of which comprises a side chain, each side chain comprising an electron transport moiety, wherein said two electron transport moieties are different. More preferably, said two different electron transport moieties are oxadiazole and starburst oxadiazole.

Preferably, repeating units containing the multiple charge transport moieties range from 0.05 to 100 mol %, and more preferably from 70 to 100 mol %, in the backbone of the polymer,.

Preferably, said conjugated polymer further comprises a crosslinkable function group.

Preferably, said conjugated polymer further comprises a side chain comprising a fluorescent group, and said fluorescent group is diphenylamino-di(styryl)arylene) or bis(diphenyl)aminostyryl benzene.

Preferably, the electroluminescent material of the present invention is a phosphorescent organometallic complex grafted with said multiple charge transport moieties. More preferably, said organometallic complex is grafted with a side chain comprising said multiple charge transport moieties. Most preferably, said side chain further comprises a spacer linking every two adjacent charge transport moieties of said multiple charge transport moieties. Said spacer is preferably selected from the group consisting of an alkylene, an alkylene containing heteroatoms, a substituted alkylene, a substituted alkylene containing heteroatoms, an aromatic group, a heterocyclic aromatic group, a substituted aromatic group, a substituted heterocyclic aromatic group, and a combination thereof. More preferably, said spacer comprises hexylene.

Preferably, said side chain of said organometallic complex further comprises another spacer connecting said linked multiple charge transport moieties to said organometallic complex. Said another spacer is preferably selected from the group consisting of an alkylene, an alkylene containing heteroatoms, a substituted alkylene, a substituted alkylene containing heteroatoms, an aromatic group, a heterocyclic aromatic group, a substituted aromatic group, a substituted heterocyclic aromatic group, and a combination thereof. More preferably, said another spacer comprises hexylene.

Preferably, said side chain of said organometallic complex comprises two charge transport moieties, and said two charge transport moieties are both hole transport moieties or both electron transport moieties.

Preferably, said organometallic complex is an Ir—, Pt—, Os— or Rb-complex, and said organometallic complex comprises an element of O, N, S, P, Cl, Br, or C, and a heterocyclic ring, which coordinates Ir, Pt, Os or Rb. More preferably, said organometallic complex is an Ir—, or Pt-complex. Said heterocyclic ring preferably is 2-phenylpyridine, 2-benzo[4,5-a]thienylpyridine, (4,6-difluoro)phenylpyridine, 2-phenylbenzothiolate, acetylacetonate, or picolinate.

The present invention also provides an organic light emitting diode, which comprises: a positive electrode formed on a substrate; a negative electrode; and a light emitting layer disposed between said positive electrode and said negative electrode, wherein said light emitting layer comprises an electroluminescent material grafted with multiple charge transport moieties with graded ionization potential or electrophilic property.

Preferably, the organic light emitting diode further comprises an electron transporting layer formed between said light emitting layer and said negative electrode.

Preferably, the organic light emitting diode further comprises a hole transporting layer formed between said positive electrode and said light emitting layer.

Preferably, the organic light emitting diode emits red light, yellow light, green light, blue light, white light or light with broad band containing multiple color peaks.

### BRIEF DESCRIPTION OF THE DRAWINGS

FIG. 1 is a schematic illustration of the structure of a multiple-layered organic light emitting diode device of the present invention.

FIG. 2a is a plot showing the relationship between current density-voltage-brightness of polymer light emitting diodes (PLEDs) prepared with electroluminescent conjugated polymers TPA-Cz-sPF and Cz-TPA-sPF in Example 8 of the present invention.

FIG. 2b is a plot showing the relationship between current density-voltage-brightness of an organic light emitting diode (OLED) prepared with a phosphorescent iridium complex in Example 8 of the present invention.

FIG. 3a shows the EL spectra of the PLEDs shown in FIG. 2a.

FIG. 3b shows the EL spectrum of the OLED shown in FIG. 2b.

### DETAILED DESCRIPTION OF THE INVENTION

The present invention synthesizes a novel electroluminescent material grafted with charge transporting moieties having graded ionization potential or electrophilic properties to elevate device efficiency via providing efficient charge injection. The electroluminescent conjugated polymer synthesized in the present invention can be used to make a light emitting diode emitting the light such as red, yellow, green, blue and white. The single layer device based on the electroluminescent conjugated polymer and iridium complex designed by this invention exhibit the highest efficiency 7.53% (10 lm/W) and 10.87% (20.11 cd/A) and far superior to others reported in the literature.

One aspect of the present invention is to provide an electroluminescent conjugated polymer grafted with multiple charge transport moieties with graded ionization potential or electrophilic property relative to that of its backbone. The backbone of the conjugated polymer comprise the following two repeating units with a number average molecular weight of 1,000 to 2,000,000:

—(Ar¹)ₓ—

—(Ar²)_{y}—

wherein x and y represent the moles of the two repeating units Ar¹ and Ar², respectively, and x:y=1:10 to 10:1; and Ar¹ and Ar² are independently selected from the group consisting of mono-, bicycle- and polycyclic aromatic groups; heterocyclic aromatic group; substituted aromatic group; and substituted heterocyclic group, wherein each of Ar¹ and Ar² comprises a side chain, each side chain comprising a hole transport moiety, wherein said two hole transport moieties are different; or each side chain comprising an electron transport moiety, wherein said two electron moieties are different. Suitable hole transport moiety can be a tertiary arylamine, a quarternary arylammonium salt, a tertiary heterocyclic aromatic amine, a quarternary heterocyclic aromatic ammonium, a substituted tertiary arylamine, a substituted quarternary arylammonium salt, a substituted heterocyclic aromatic amine, and a substituted quarternary heterocyclic aromatic ammonium. Suitable electron transport moiety can comprises an oxadiazole, thiodiazole, triazole, pyridine, or pyrimidine group and is selected from the group consisting of a monoheterocyclic aromatic group, biheterocyclic aromatic group and polyheterocyclic aromatic group.

The conjugated polymer of the present invention can be a homopolymer or copolymer, for examples those having a backbone formed by one of more of the following repeating units:

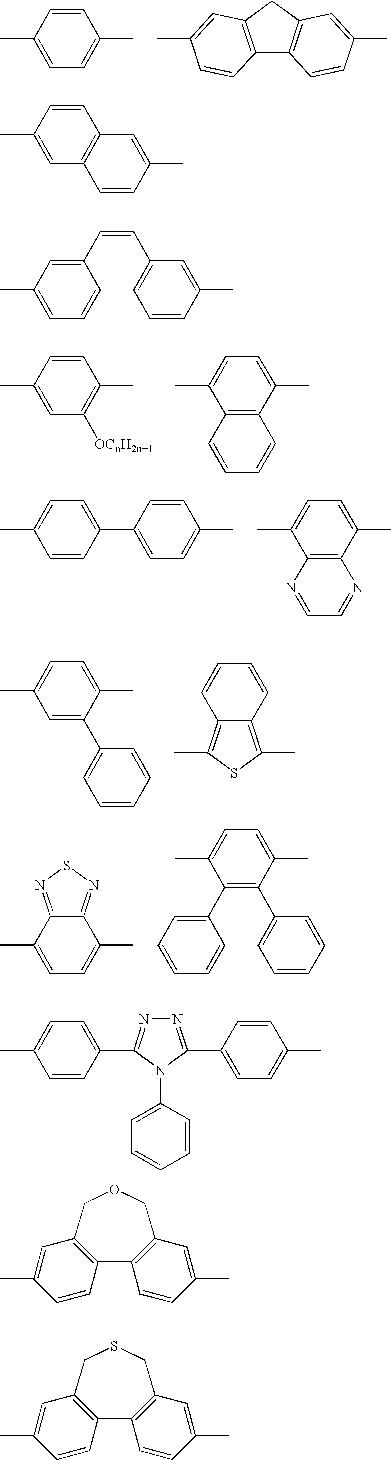

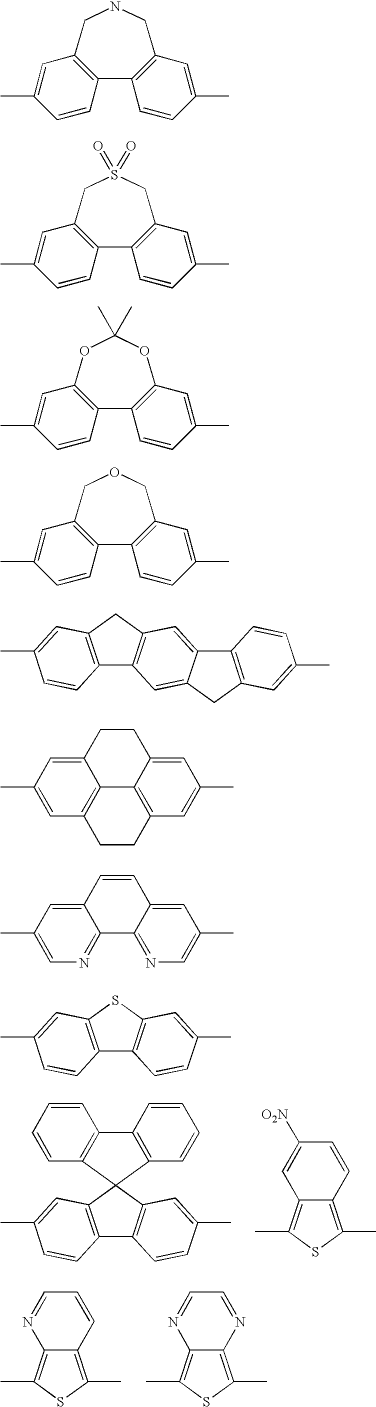

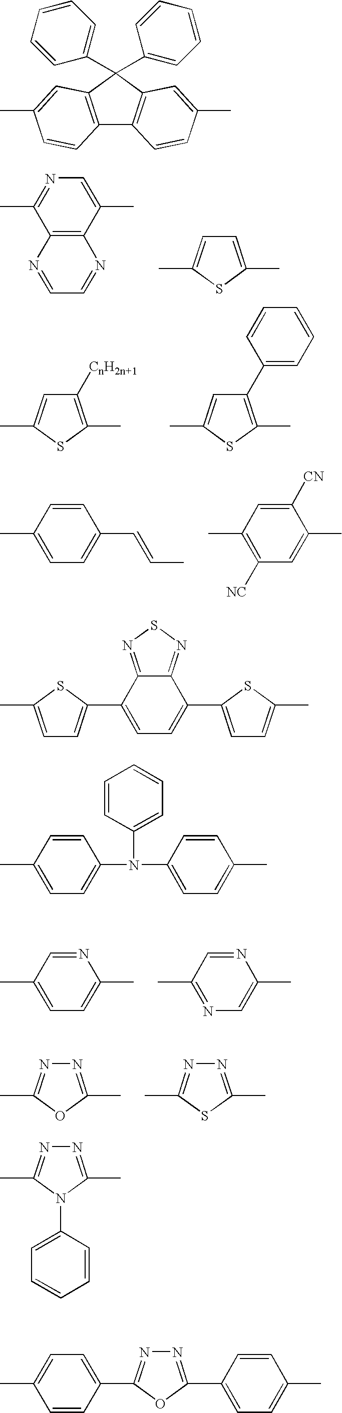

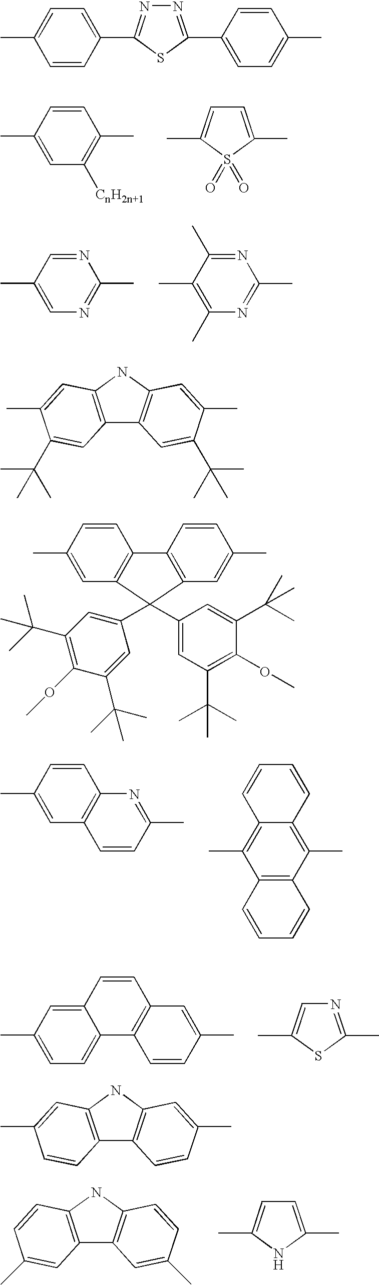

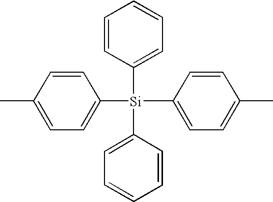

The hole transport moiety suitable for use in the present invention include (but not limited thereto) the structures shown as follows:

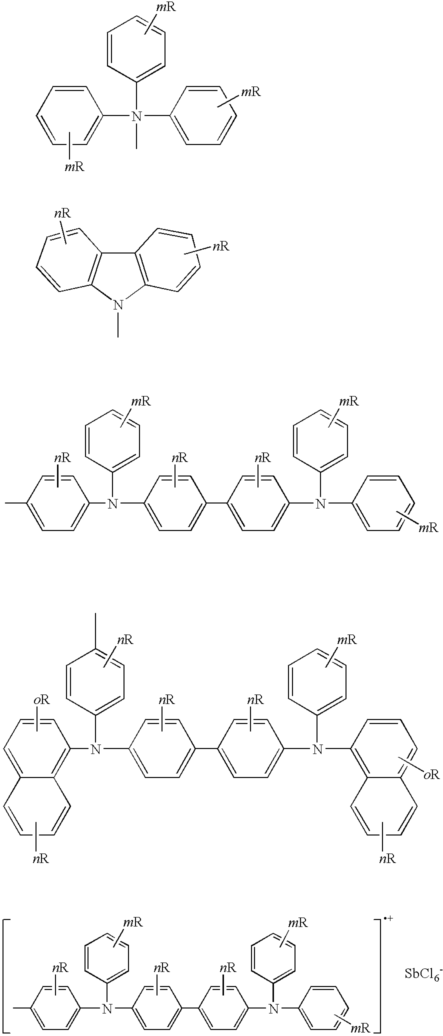

wherein m=1-5, n=1-4, o=1-3, R is H, C₁-C₂₂ alkyl, C₁-C₂₂ alkoxy, C₁-C₂₂ alkylthio, —NR^{O}₃⁺ (R^{I}═C₁-C₂₂), —NR^{I}₂ (R^{I}═C₁-C₂₂), —SiR^{I}₃ (R^{I}═C₁-C₂₂), or other soluble groups, wherein R may be identical or different either on the same ring or different rings.

The electron transport moiety suitable for use in the present invention include (but not limited thereto) the structures shown as follows:

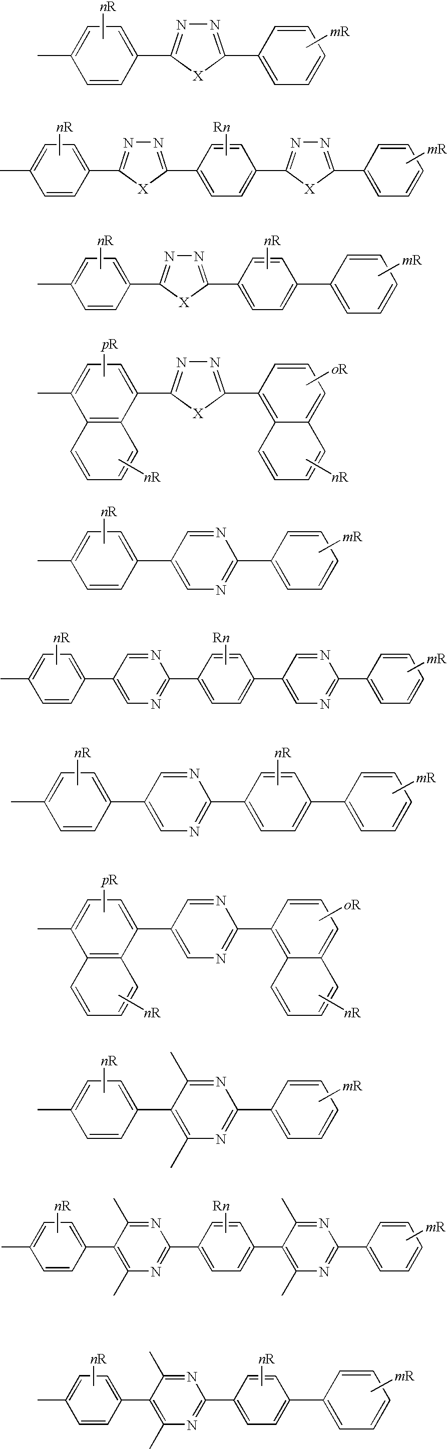

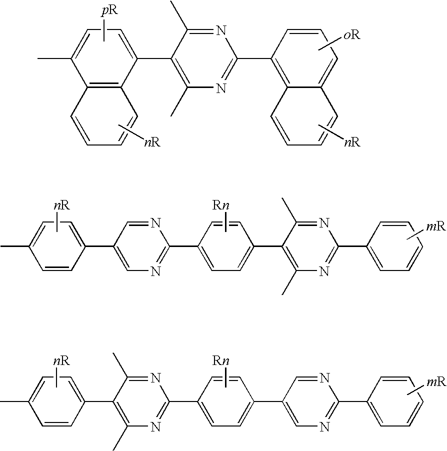

wherein m=1-5, n=1-4, o=1-3, p=1-2, R is H, C₁-C₂₂ alkyl, C₁-C₂₂ alkoxy, C₁-C₂₂ alkylthio, —NR^{I}₃⁺ (R^{I}═C₁-C₂₂), —NR^{I}₂ (R^{I}═C₁-C₂₂), —SiR^{I}₃ (R^{I}═C₁-C₂₂), or other soluble groups, wherein R may be identical or different either on the same ring or different rings; X═O, S, or N—R^{II}, wherein R^{II} is C₁-C₂₂ alkyl, C₁-C₂₂ alkoxy, phenyl, C₇-C₂₈ alkylaryl, C₇-C₂₈ alkoxyaryl, phenoxy, C₇-C₂₈ alkylphenoxy, C₇-C₂₈ alkoxyphenoxy. Diphenyl, diphenoxy, C₁₃-C₃₄ alkyldiphenyl, C₁₃-C₃₄ alkoxydiphenyl, C₁₃-C₃₄ alkyldiphenoxy, or C₁₃-C₃₄ alkoxydiphenoxy.

The conjugated polymer of the present invention can further comprise a repeating unit, which has a side chain comprising a phosphorescent moiety, a fluorescent moiety, a soluble moiety or a crosslinkable moiety. Said soluble moiety for example is a C₁-C₂₂ alkyl, C₁-C₂₂ alkoxy, C₁-C₂₂ alkylthio, —NR^{I}₃⁺ (R^{I}═C₁-C₂₂), —NR^{I}₂ (R^{I}═C₁-C₂₂), —SiR^{I}₃ (R^{I}═C₁-C₂₂), phenyl, C₇-C₂₈ alkylaryl, C₇-C₂₈ alkoxyaryl, phenoxy, C₇-C₂₈ alkylphenoxy, C₇-C₂₈ alkoxyphenoxy. Diphenyl, diphenoxy, C₁₃-C₃₄ alkyldiphenyl, C₁₃˜C₃₄ alkoxydiphenyl, C₁₃-C₃₄ alkyldiphenoxy, or C₁₃-C₃₄ alkoxydiphenoxy.

Preferably, the side chain has a spacer connecting the moiety to the repeating unit. A suitable spacer includes (but not limited thereto) a C₁-C₂₂ alkylene, a C₁-C₂₂ alkylene containing heteroatoms, a C₁-C₂₂ substituted alkylene, a C₁-C₂₂ substituted alkylene containing heteroatoms, a C₅-C₂₂ aromatic group, a C₄-C₂₂ heterocyclic aromatic group, a C₅-C₂₂ substituted aromatic group, and a C₄-C₂₂ substituted heterocyclic aromatic group.

The polymer of the present invention can be a homopolymer or a copolymer, which can be a random copolymer, block copolymer or alternating copolymer. The copolymer may comprise a non-conjugated sector among two or more conjugated sectors in a backbone of said copolymer. In the backbone of the polymer of the present invention the repeating unit containing the charge transporting moiety ranges from 0 to 99.95 mol %; and the repeating unit containing other substituent ranges from 0 to 99.95 mol %.

Preferably, the polymer of the present invention has a number average molecular weight of 1,000˜2,000,000, more preferably 5,000˜1,000,000, and most preferably 10,000˜600,000.

Another aspect of the present invention is to provide a phosphorescent organometallic complex grafted with said multiple charge transport moieties with graded ionization potential or electrophilic property.

Suitable examples of the phosphorescent organometallic complex for use in the present invention include (but not limited thereto) the structures shown as follows:

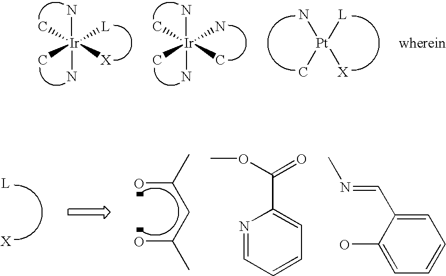

where R is alkyl or aryl, which may be different;

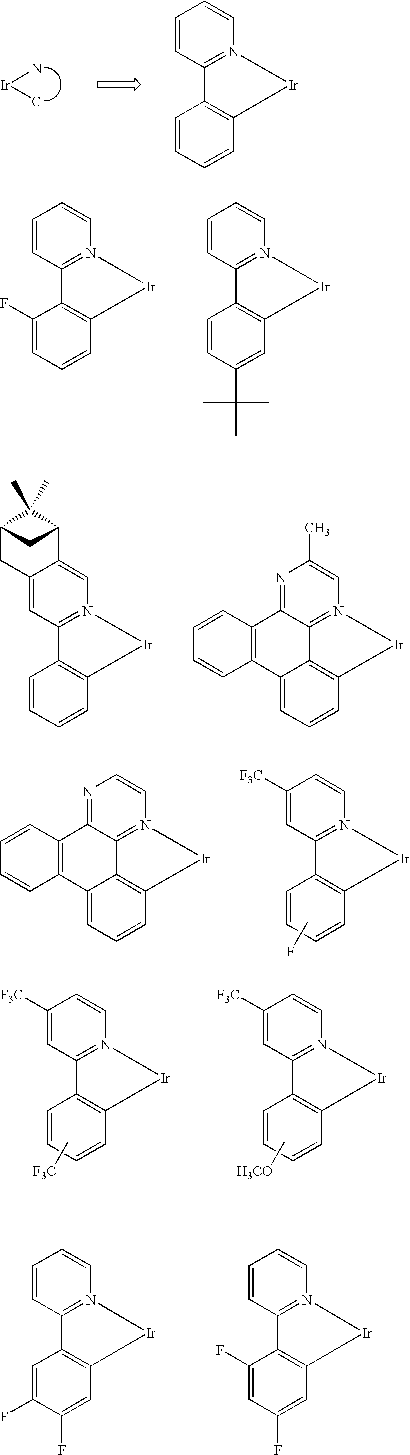

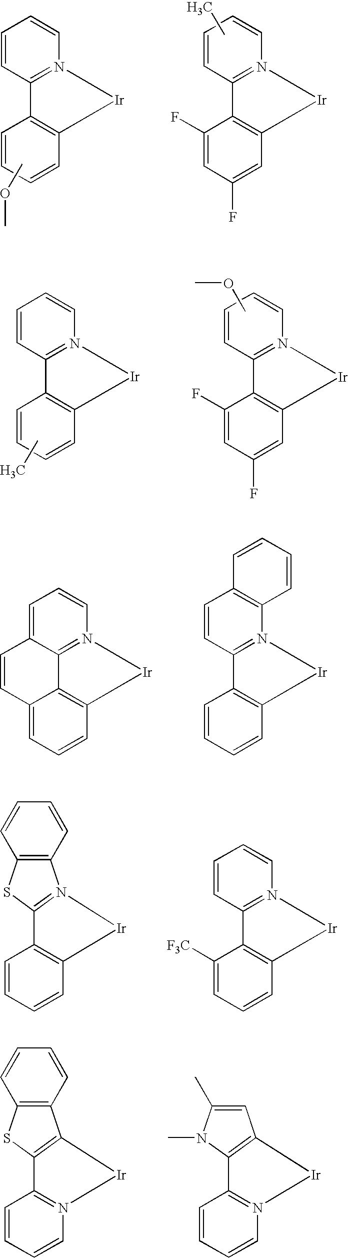

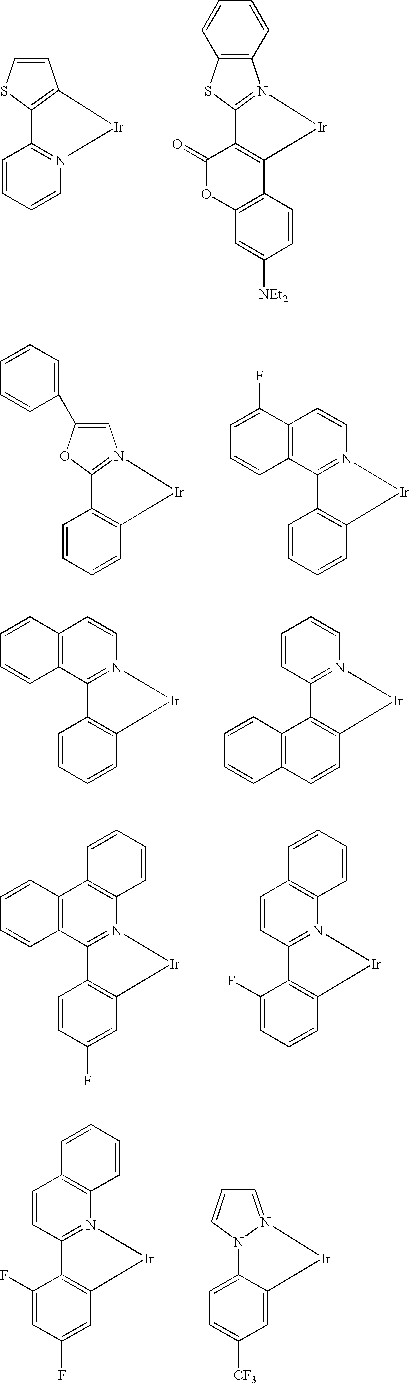

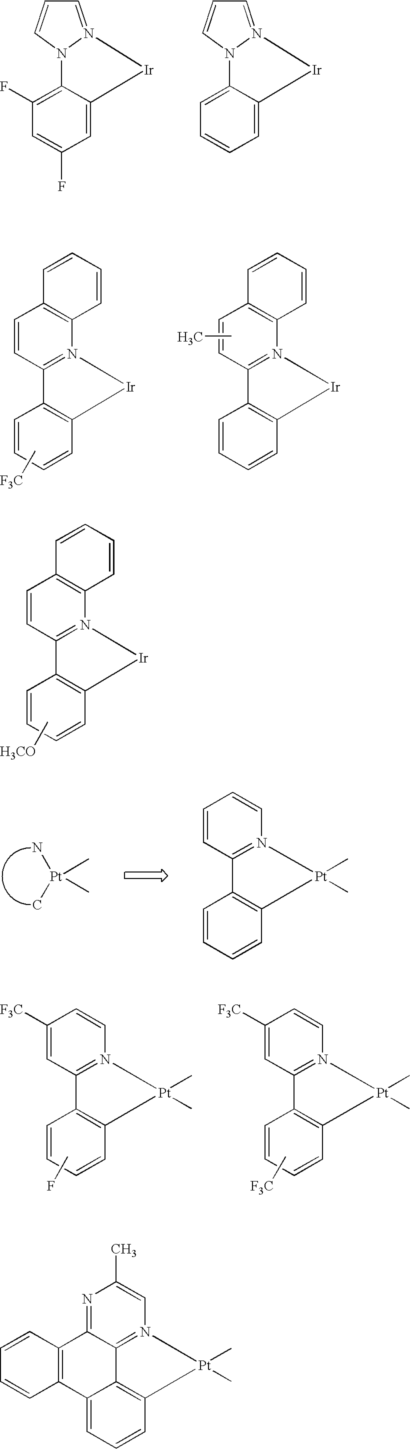

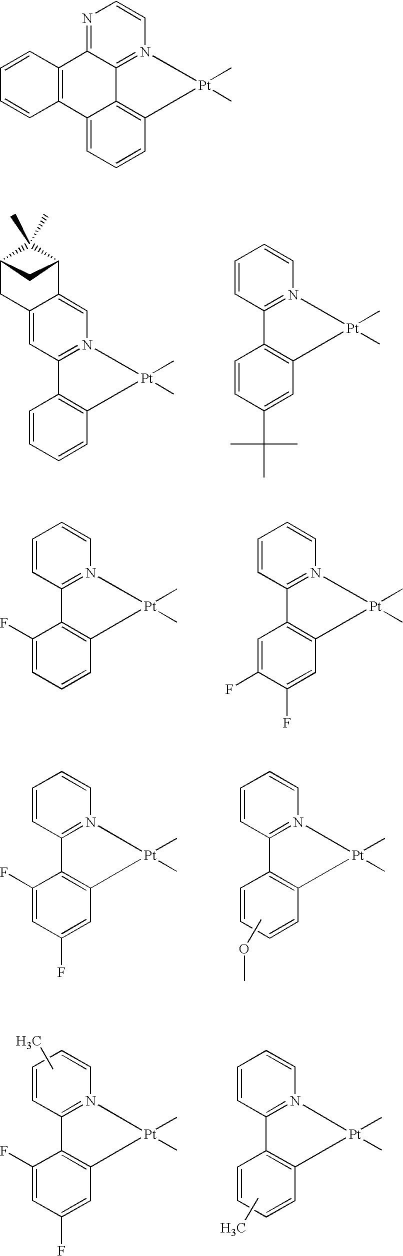

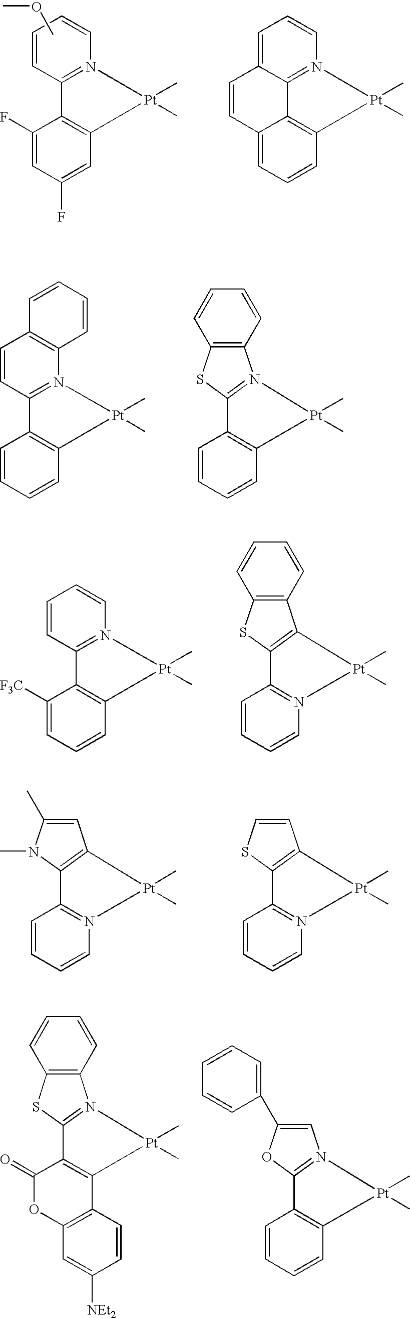

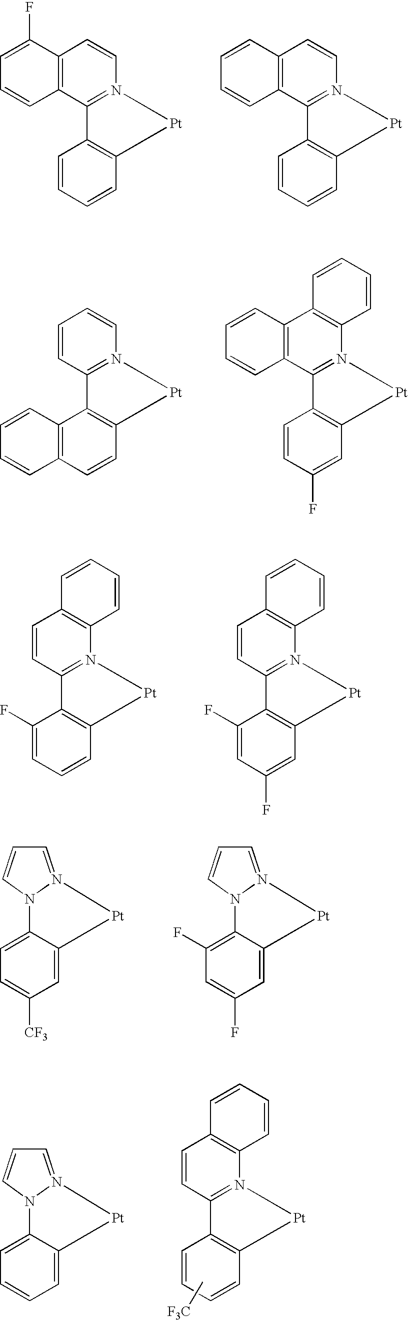

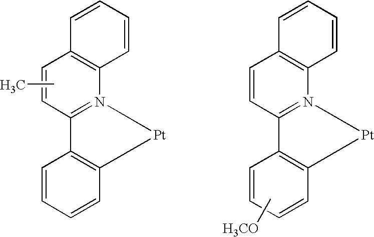

Preferably, said organometallic complex is grafted with a side chain comprising said multiple charge transport moieties. Said side chain further comprises a spacer linking every two adjacent charge transport moieties of said multiple charge transport moieties, and another spacer connecting said linked multiple charge transport moieties to said organometallic complex. A suitable spacer includes (but not limited thereto) a C₁-C₂₂ alkylene, a C₁-C₂₂ alkylene containing heteroatoms, a C₁-C₂₂ substituted alkylene, a C₁-C₂₂ substituted alkylene containing heteroatoms, a C₅-C₂₂ aromatic group, a C₄-C₂₂ heterocyclic aromatic group, a C₅-C₂₂ substituted aromatic group, and a C₄-C₂₂ substituted heterocyclic aromatic group. In one of the preferred embodiments of the present invention, said side chain comprises two charge transport moieties, and said two charge transport moieties are both hole transport moieties or both electron transport moieties.

The ionization potentials (or electrophilic property) of charge transporting moiety can be determined by cyclic voltammetry (CV), but not restricting to this approach, detailed measurement procedure is described as follows: the method uses a reference electrode, working electrode, and counter electrode which in combination are referred to as a three-electrode setup. Electrolyte is usually added to test solution to ensure sufficient conductivity. CV is a type of potentiodynamic electrochemical measurement. In a CV experiment, the working electrode potential is ramped linearly versus time like linear sweep voltammetry. CV takes the experiment a step further than linear sweep voltammetry which ends when it reaches a set potential. When CV reaches a set potential the working electrode's potential is inverted. When the applied potential reaches the oxidation/reduction potential of the electroactive material, oxidation/reduction reaction occurs and to give oxidation/reduction current. The energy level of the investigated material is defined by using a standard (e.g. ferrocene). Taking the onset oxidation/reduction potential determined from the CV measurement and the oxidation/reduction potential of ferrocene we can determine the ionization potential (or electrophlic property). The energy gap between oxidation potential of ferrocene and vacuum level is 4.8 eV. As a result, the ionization potential (or electrophilic property) of the investigated material can be determined by using the following equation 1 and 2:

LUMO level=−e(Eᵣₑ−E_{1/2}, ferrocene)+(−4.8)eV (equation 1)

HOMO level=−e(Eₒₓ−E_{1/2}, ferrocene)+(−4.8)eV (equation 2)

wherein −e(Eᵣₑ−E_{1/2}, ferrocene) represents a difference between the reduction potentials of the tested material and the standard, and −e(Eₒₓ−E_{1/2}, ferrocene) represents a difference between the oxidation potentials of the tested material and the standard.

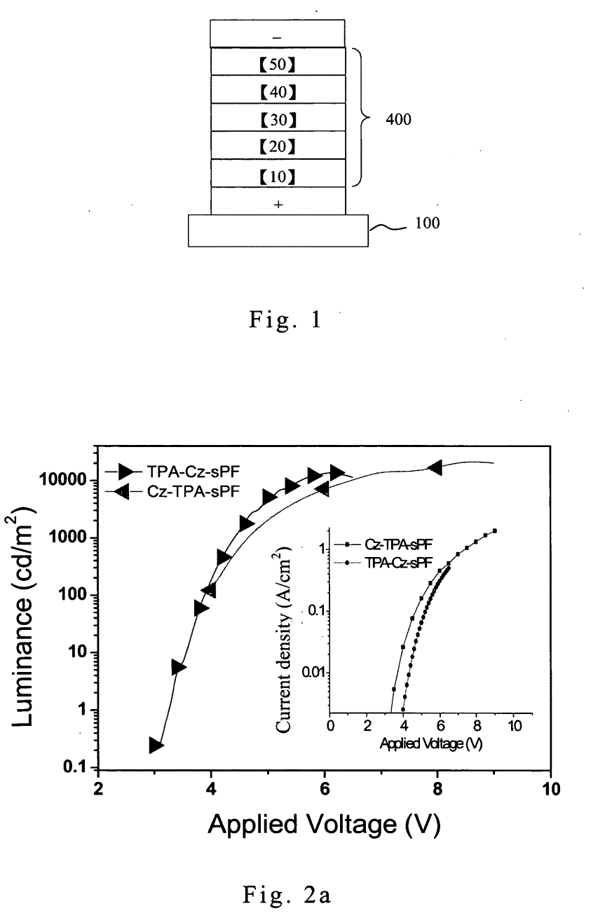

A further aspect of the present invention is to provide an organic light emitting diode (OLED) prepared with the electroluminescent material of the present invention. The structure of an OLED is a two layered, three layered, or multiple layered structure. FIG. 1 is a schematic diagram of a multiple layered OLED device, wherein the actual thickness of each layer is independent of the dimension depicted in the drawing. The structure of the multiple layered OLED device sequentially comprises a substrate 100, an anode (+), a hole injection modification layer 10, a hole transporting layer 20, an electron-blocking layer (not shown in the drawing), a light emitting layer 30, a hole-blocking layer 40, an electron transporting layer 50, and a cathode (−). Said electron-blocking layer, hole injection modification layer 10, and hole-blocking layer 40, depending on the requirements of said device, may or may not be included in the structure thereof, wherein the layers between the positive electrode and the negative electrode constitute an electroluminescent medium 400 of said device. Said light emitting layer 30 is formed by doping a phosphorescence material as a dopant in a host compound.

The hole transporting layer 20 and the electron-blocking layer are omitted when the electroluminescent material grafted with two different hole transport moieties of the present invention is used to prepare the light emitting layer 30 of the OLED device. The electron transporting layer 50 is omitted when the electroluminescent material grafted with two different electron transport moieties of the present invention is used to prepare the light emitting layer 30 of the OLED device. Accordingly, a process for manufacturing an OLED device is simplified, when the electroluminescent material of the present invention is used to prepare the light emitting layer thereof.

Examples of the conjugated polymer and organometallic complex of the present invention are shown by the following structures (I) to (IV):

### The Structure (I): Polymer Cz-TPA-sPF

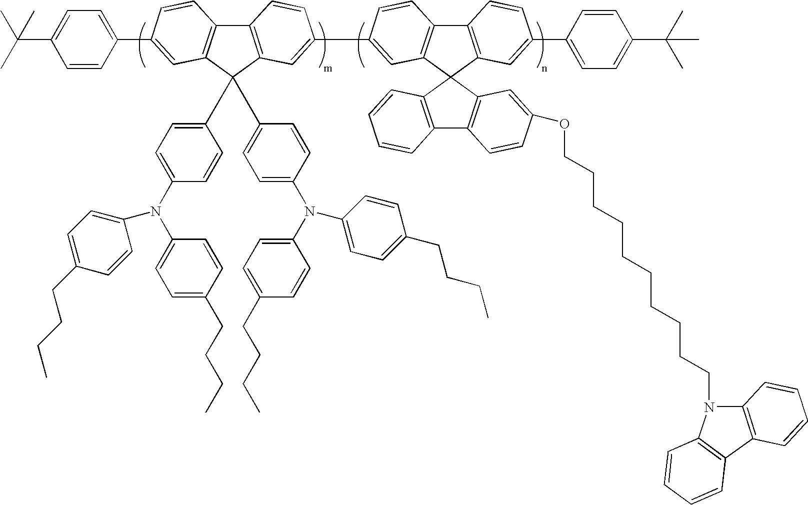

wherein the polymer Cz-TPA-sPF has m=47 mol %, and n=53 mol %.

### The Structure (II): Polymer TPA-Cz-sPF

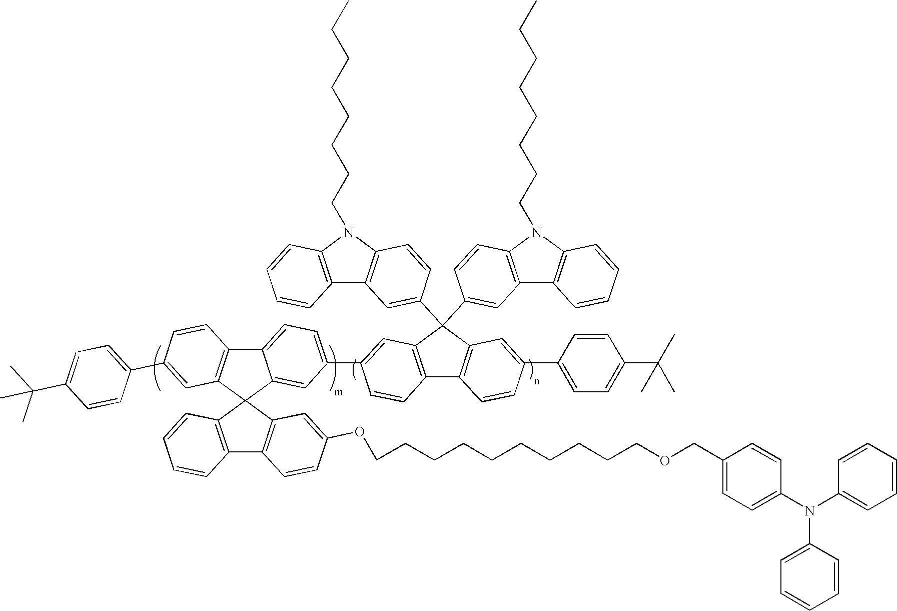

wherein the polymer TPA-Cz-sPF has m=52 mol %, and n=48 mol %.

### The Structure (III): Polymer 25 G-sPF, 50 G-sPF, 75 G-sPF and 100 G-sPF

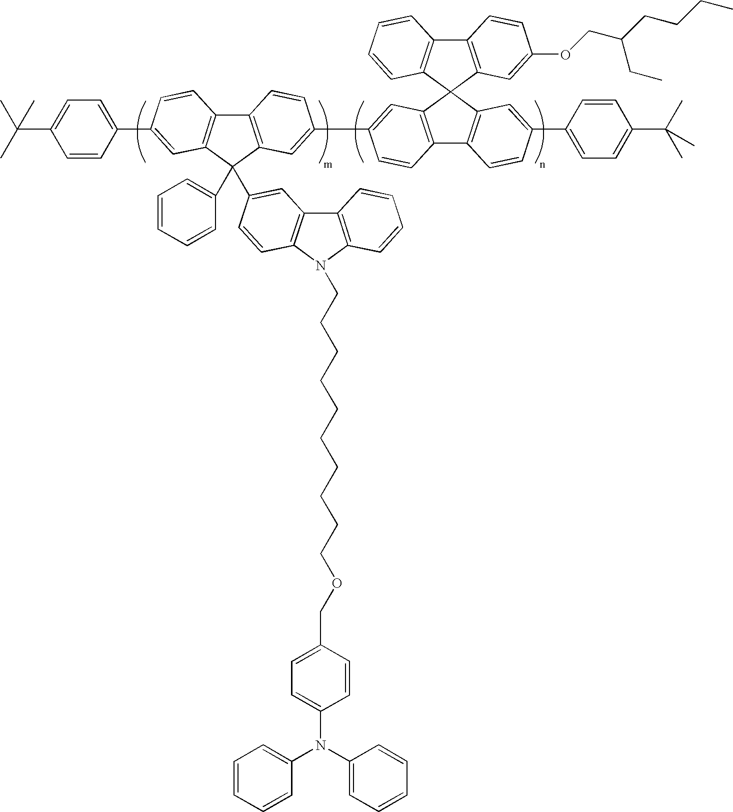

wherein the polymer 25 G-sPF has m=25 mol %, and n=75 mol %; the polymer 50 G-sPF has m=50 mol %, and n=50 mol %; the polymer 75 G-sPF has m=75 mol %, and n=25 mol %; the polymer 100 G-sPF has m=100 mol %, and n=0 mol %.

### The Structure (IV): Iridium Complex FirpicOCzOTPA

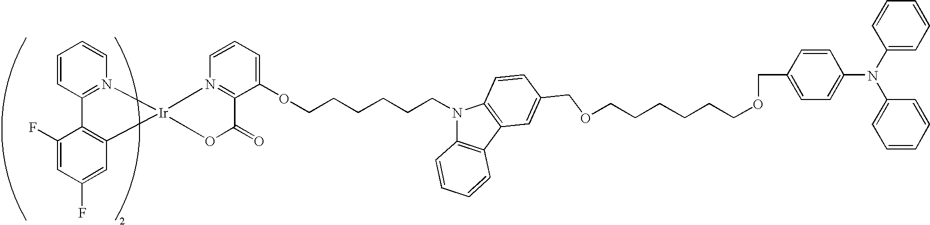

For the above conjugated polymers and iridium complex grafted with dual hole transporting moieties (triphenylamine and carbazole), the ionization potentials for triphenylamine, carbazole and main chain (polyfluorene) are 5.3, 5.5 and 5.7 eV. When using the anode (poly(3,4-ethylenedioxythiophene) (PEDOT) coated ITO substrate, with the work function 5.3 eV), these four electroluminescent materials all exhibit graded ionization potential relative to the main chain as depicted in the following:

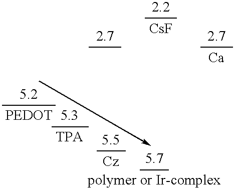

Assuming a polymer whose LUMO level is 2.8 eV (e. g. poly[2-(29-ethylhexyloxy)-5-methoxy-1,4-phenylene vinylene] (MEHPPV)), while grafting with electron transporting moieties of oxadiazole (OXD-7) and starburst oxadiazole (starburst OXD) that LUMO levels are 2.8 and 3.2, respectively. When using the cathode Al (work function 4.3 eV), this polymer exhibits graded electronic profile for electron relative to the main chain as depicted in the following:

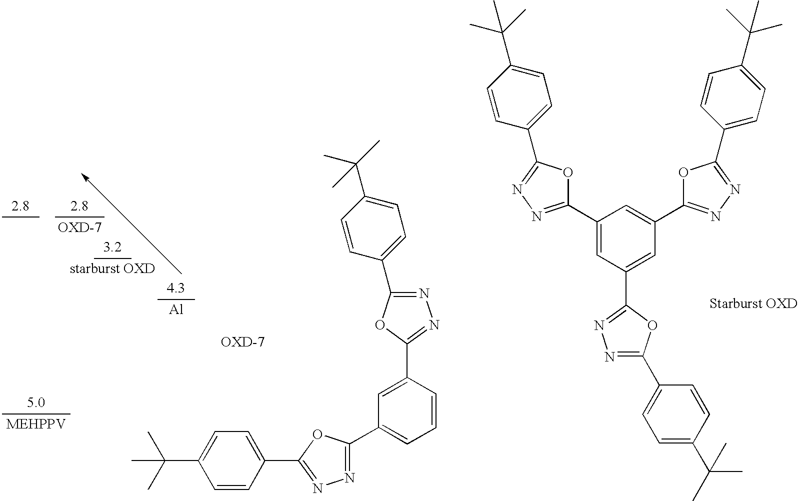

The present invention will be elucidated by the following examples, which are illustrated only and not for limiting the scope of the present invention.

The polymer of the present invention can be synthesized by copolymerizing suitable monomers which are able to form a conjugated polymer, for example, via the coupling reaction disclosed by Suzuki or Yamamoto. The following compounds are examples of the suitable materials for synthesis of the polymer and the iridium complex of the present invention, which are merely illustrated and not for restricting the scope of the present invention.

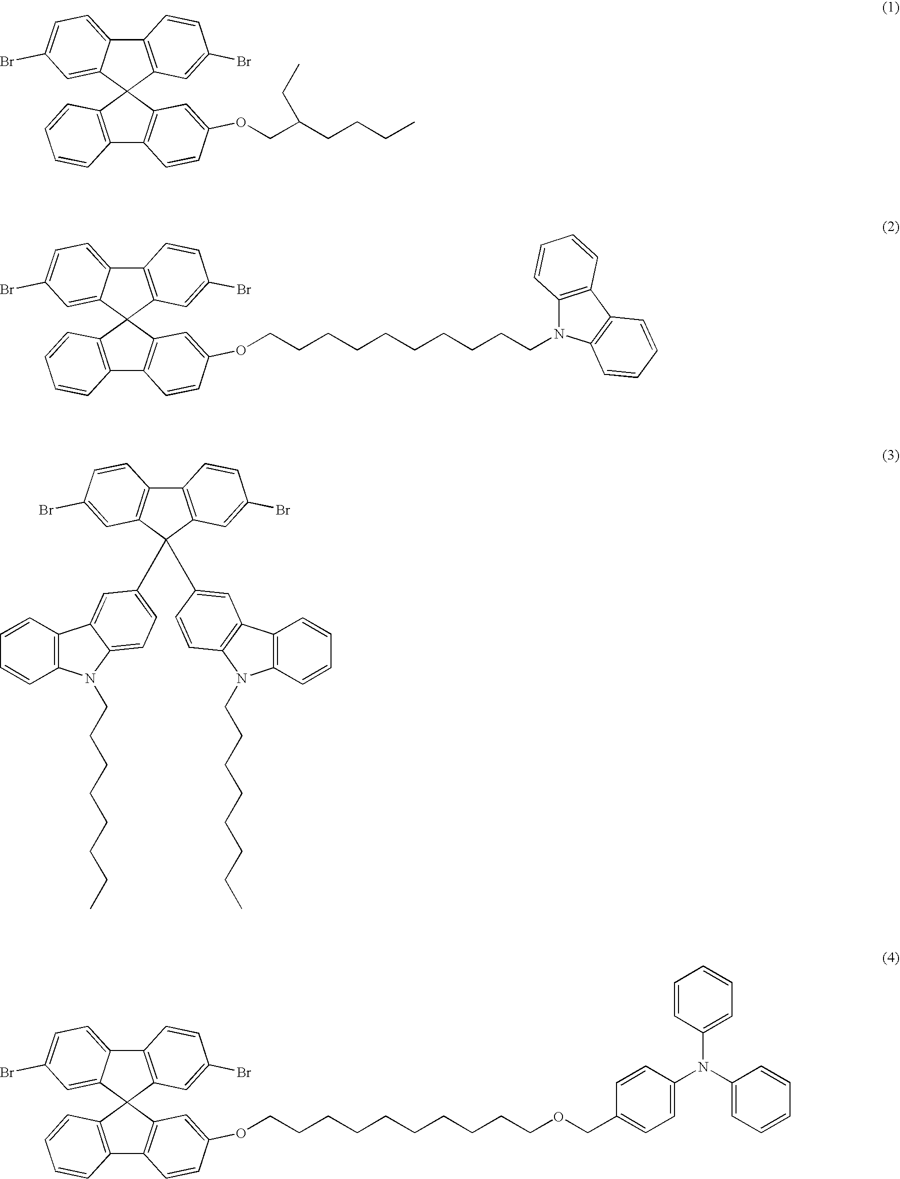

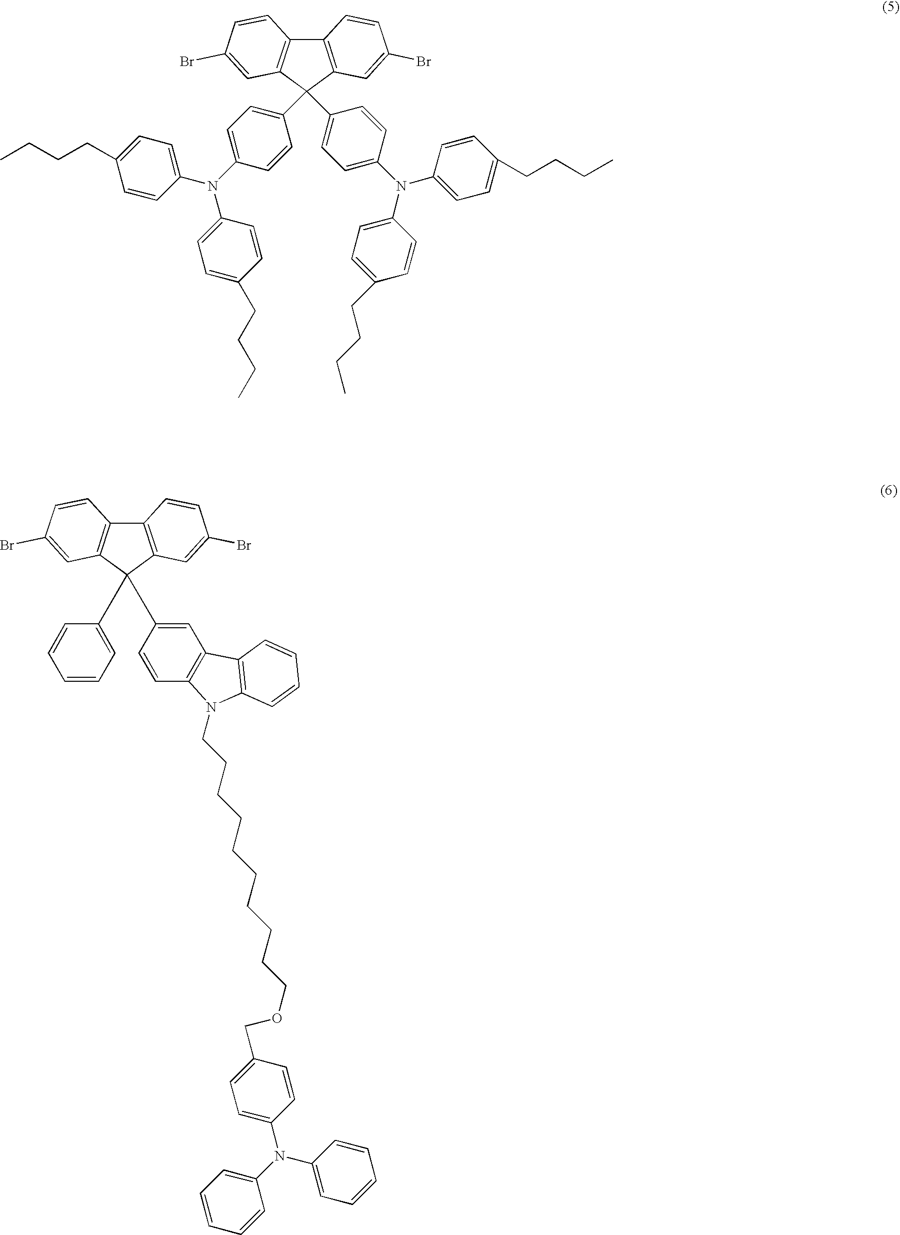

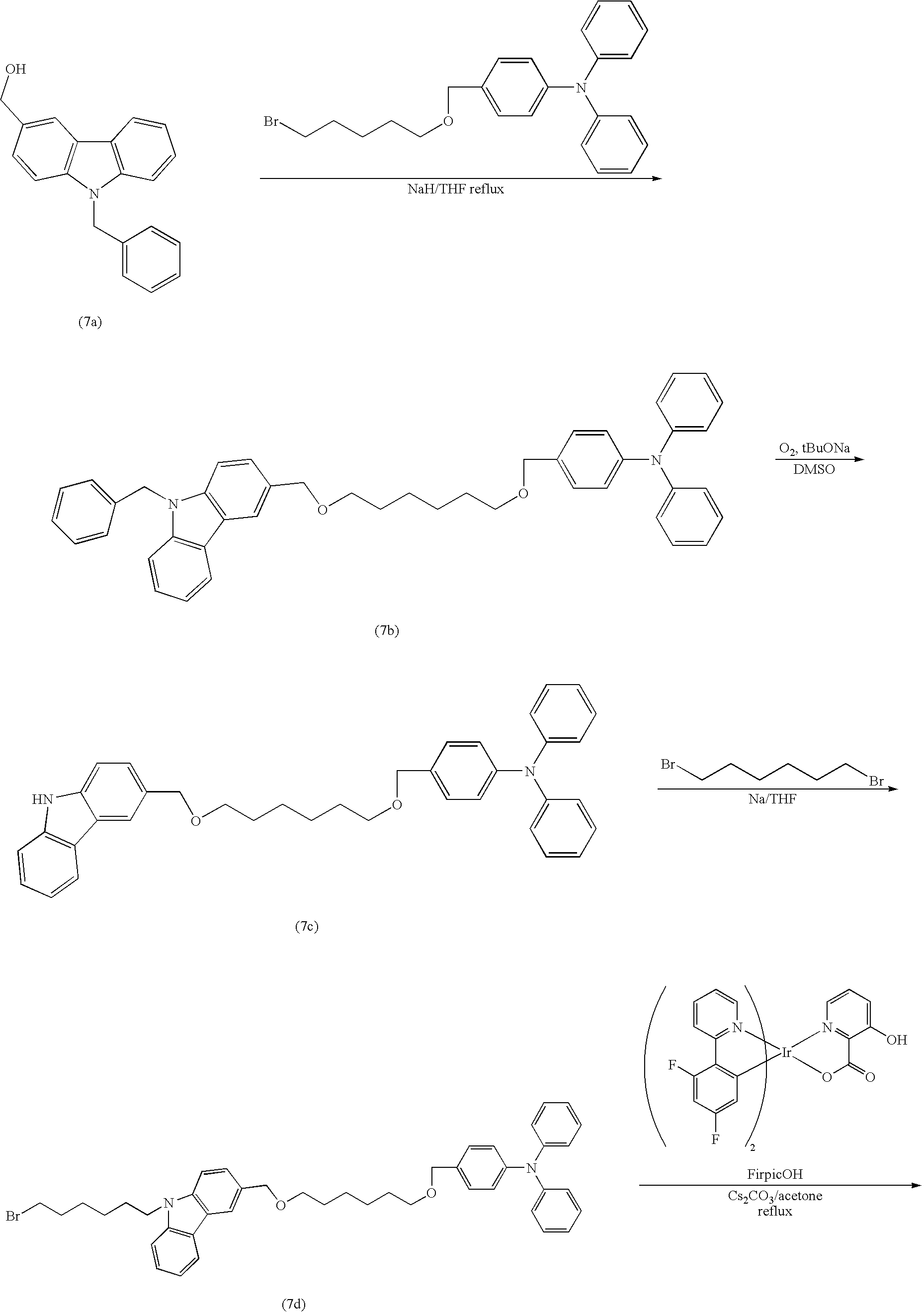

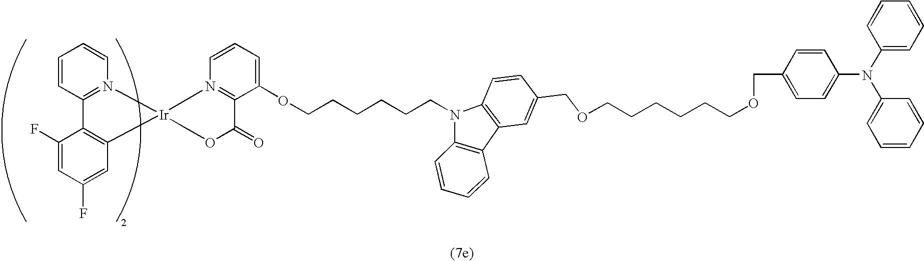

### EXAMPLE 1

2,7-dibromo-2′-ethylhexyl-9,9′-spirobifluorene (1). A mixture of 2,7-dibromo-2′-hydroxy-9,9′-spirobifluorene (2 g, 4.08 mmol), 1-bromoethylhexane (0.867 g, 4.49 mmol), K₂CO₃ (1.375 g, 10.37 mmol) and 18-crown-6 (7.5 mg) in dry acetone was heated to reflux and stirred vigorously under nitrogen overnight. After removing the solvent, the reaction residue was partitioned between water and CH₂Cl₂ phases; after separating the organic layers, the aqueous layer was extracted with CH₂Cl₂. The combined organic layer was dried over MgSO₄. Removed the solvent and the crude product was purified by column chromatography packed with silica gel eluting with hexane increasing to CH₂Cl₂/hexane at 1:1 by volume to afford a white solid 2.33 g (95%). ¹H NMR (400 MHz, CDCl₃): δ 7.73 (dd, 2H), 7.67 (d, 2H), 7.49 (dd, 2H), 7.36 (t,1H), 7.06 (t, 1H), 6.94 (dd, 1H), 6.86 (d, 2H), 6.65 (d, 1H), 6.22 (d, 2H), 3.69 (t, 2H), 1.57 (m, 1H), 1.37 (m, 8H), 0.85 (t, 6H); ¹³C NMR (100 MHz, CDCl₃): δ 159.9, 150.8, 148.7, 146.7, 141.8, 139.6, 134.3, 131.1, 128.2, 127.5, 126.8, 123.8, 121.9, 121.3, 121.0, 119.3, 114.5, 110.4, 70.8, 65.6. 39.5, 30.5, 29.1, 23.8, 23.0, 14.0, 11.1. LR-MS(FAB) calculated C₃₃H₃₀Br₂O: m/z=602.40. Found: m/z=602.

### EXAMPLE 2

2,7-dibromo-2′-N-carbazolyl-decyl-9,9′-spirobifluorene (2). A mixture of 2,7-dibromo-2′-hydroxy-9,9′-spirobifluorene (2 g, 4.08 mmol), 9-(10-bromodecyl)-9H-carbazole (1.73 g, 4.49 mmol), K₂CO₃ (1.375 g, 10.37 mmol) and 18-crown-6 (7.5 mg) in dry acetone was heated to reflux and stirred vigorously under nitrogen overnight. After removing the solvent, the reaction residue was partitioned between water and CH₂Cl₂ phases; after separating the organic layers, the aqueous layer was extracted with CH₂Cl₂. The combined organic layer was dried over MgSO₄. Removed the solvent and the crude product was purified by column chromatography packed with silica gel eluting with hexane increasing to CH₂Cl₂/hexane to 3:1 to afford a white solid 2.92 g (90%). ¹H NMR (400 MHz, CDCl₃): δ 8.07 (d, 2H), 7.71 (m, 2H), 7.62 (d, 2H), 7.36 (m, 7H), 7.19 (td, 2H), 7.04 (td, 1H), 6.90 (dd, 1H), 6.83 (d, 2H), 6.64 (d, 1H), 6.20 (d, 1H), 4.28 (t, 2H), 3.78 (t, 2H), 1.83 (m, 2H), 1.62 (m, 2H), 1.32˜1.12 (m, 12H); ¹³C NMR (100 MHz, CDCl₃): δ159.6, 150.8, 148.8, 146.6, 141.8, 140.4, 139.6, 134.4. 131.1, 120.2, 127.4, 126.8, 125.5, 123.9, 122.8, 121.9, 121.3, 121.0 120.3, 119.4, 118.7, 114.4, 110.3, 108.6, 68.1, 65.6, 43.1, 29.3, 29.3, 29.0, 27.3, 26.0. LR-MS(FAB) calculated C₄₇H₄₁Br₂NO: m/z=795.64. Found: m/z=795.

### EXAMPLE 3

9,9-Bis(3,3′-N-octyl-9H-carbazole)-2,7-dibromofluorene (3). To a mixture of 2,7-dibromofluorenone (3.15 g, 9.31 mmol) and 9-octyl-9H-carbazole (7.80 g, 27.93 mmol) were added methanesulfonic acid (600 μL, 0.93 mmol). The reaction mixture was heated at 90° C. under inert atmosphere overnight. The cooled mixture was quenched by aqueous sodium carbonate and extracted with CH₂Cl₂. The combined organic layer was dried over MgSO₄. Removed the solvent and the crude product was purified by column chromatography packed with silica gel eluting with hexane increasing to CH₂Cl₂/hexane to afford a slight yellow crystal 2.69 g (33%). ¹H NMR (400 MHz, CDCl₃): δ 8.07 (d, 2H), 8.01 (d, 2H), 7.79 (s, 2H), 7.65 (d, 2H), 7.55 (d, 2H), 7.47 (m, 4H), 7.32 (d, 2H), 7.21 (d, 2H), 4.25 (t, 4H), 1.88 (m, 4H), 1.36 (m, 20H), 0.98 (t, 6H); ¹³C NMR (100 MHz, CDCl₃): δ 154.62, 140.74, 139.43, 137.93, 135.43, 130.63, 129.63, 126.05, 125.66, 122.64, 122.54, 121.78, 121.53, 120.42, 119.50, 118.68, 108.68, 108.63, 65.88, 43.03, 31.75, 31.56, 29.31, 29.12, 18.96, 27.25, 22.63, 22.57, 14.11, 14.06. LR-MS(FAB) calculated C₅₃H₅₄Br₂N₂: m/z=878.81. Found: m/z=878.

### EXAMPLE 4

2,7-dibromo-2′-4-((10-bromodecyloxy)methyl)-N,N-diphenylbenzenamine-9,9′-spirobifluorene (4). A mixture of 2,7-dibromo-2′-hydroxy-9,9′-spirobifluorene (2 g, 4.08 mmol), 4-((10-bromodecyloxy)methyl)-N,N-diphenylbenzenamine (2.22 g, 4.49 mmol), K₂CO₃ (1.375 g, 10.37 mmol) and 18-crown-6 (7.5 mg) in dry acetone was heated to reflux and stirred vigorously under nitrogen overnight. After removing the solvent, the reaction residue was partitioned between water and CH₂Cl₂ phases; after separating the organic layers, the aqueous layer was extracted with CH₂Cl₂. The combined organic layer was dried over MgSO₄. Removed the solvent and the crude product was purified by column chromatography packed with silica gel eluting with hexane increasing to CH₂Cl₂/hexane to afford a white solid 3.44 g (85%). ¹H NMR (400 MHz, CDCl₃): δ 7.71 (t, 2H), 7.63 (d, 2H), 7.46 (dd, 2H), 7.34 (t, 1H), 7.21 (m, 6H), 7.04 (t, 6H), 6.97 (t, 2H), 6.91 (dd, 2H), 6.83 (s, 2H), 6.64 (d, 1H), 6.20 (d, 1H), 4.41 (s, 2H), 3.78 (t, 2H), 3.45 (t, 2H), 1.62 (m, 4H) 1.32 (m, 12H); ¹³C NMR (100 MHz, CDCl₃): δ 159.59, 150.75, 148.76, 147.78, 147.18, 146.60, 141.73, 139.54, 134.31, 132.89, 131.07, 129.15, 128.81, 128.21, 127.39, 126.79, 123.99, 122.63, 121.32, 120.97, 119.38, 114.36, 110.25, 72.57, 70.57, 68.13, 65.55, 29.72, 29.42, 29.34, 29.24, 26.15, 25.96. LR-MS(FAB) calculated C₅₄H₄₉Br₂NO₂: m/z=903.78. Found: m/z=903.

### EXAMPLE 5

9,9-Bis(4-di(4-butylphenyl)aminophenyl)-2,7-dibromofluorene (5). To a mixture of 2,7-dibromofluorenone (3.15 g, 9.3 mmol) and 4,4′dibutyltriphentlamine (10 g, 28 mmol) was added methanesulfonic acid (600 μL, 9.3 mmol). The reaction mixture was then heated at 140° C. under nitrogen overnight. The cooled mixture was diluted with dichloromethane and washed with aqueous sodium carbonate. The organic phase was dried over MgSO₄, and the solvent was evaporated. The crude product was purified by column chromatography, eluting with hexane increasing to CH₂Cl₂/hexane to afford a white solid 6.36 g (66%). ¹H NMR (400 MHz, CDCl₃): δ7.54 (d, 2H), 7.50 (d, 2H), 7.44 (dd, 2H), 7.03 (d, 8H), 6.97 (d, 8H), 6.94 (d, 4H), 6.84 (d, 4H), 2.54 (t, 8H), 1.56 (m, 8H), 1.34 (m, 8H), 0.91 (t, 12H); ¹³C NMR (100 MHz, CDCl₃): δ 153.7, 147.1, 145.2, 137.9, 137.7, 136.6, 130.7, 129.4, 129.1, 128.5, 124.8, 121.7, 121.6, 121.4, 64.6, 35.0, 33.6, 22.4, 14.0. LR-MS(FAB) calculated C₆₅H₆₆Br₂N₂: m/z=1035.04 Found: m/z=1035.

### EXAMPLE 6

N-(4-((10-(3-(2,7-dibromo-9-phenyl-9H-fluoren-9-yl)-9H-carbazol-9-yl)decyloxy)methyl)phenyl)-N-phenylbenamine (6). 3-(2,7-dibromo-9-phenyl-9H-fluoren-9-yl)-9H-carbazole (2 g, 3.53 mmol) and NaH (0.212 g, 8.83 mmol) in dry THF was heated to reflux and stirred vigorously under nitrogen for 2 h. Then, N-(4-((10-bromodecyloxy)methyl)phenyl)-N-phenylbenzenamine (2.62 g, 5.29 mmol) in dry THF was added in one portion and was further heated to reflux and stirred vigorously under nitrogen overnight. After removing the solvent, the reaction residue was partitioned between water and CH₂Cl₂ phases; after separating the organic layers, the aqueous layer was extracted with CH₂Cl₂. The combined organic layer was dried over MgSO₄. Removed the solvent and the crude product was purified by column chromatography packed with silica gel eluting with hexane increasing to CH₂Cl₂/hexane to afford a white solid 3.01 g (87%). ¹H NMR (400 MHz, CDCl₃): δ 7.92 (d, 1H), 7.80 (d, 1H), 7.60 (d, 2H), 7.55 (d, 2H), 7.47 (dd, 2H), 7.39 (dd, 1H), 7.38 (d, 1H), 7.23 (m, 13H), 7.14 (td, 2H), 7.04 (td, 6H), 6.97 (tt, 2H), 4.41 (s, 2H), 4.22 (t, 2H), 3.45 (t, 2H), 1.84 (m, 2H), 1.56 (m, 2H), 1.31 (m, 12H); ¹³C NMR (100 MHz, CDCl₃): δ 153.84, 147.82, 147.23, 145.24, 140.82, 139.50, 138.04, 134.60, 132.94, 13.0.83, 129.56, 129.17, 128.82, 128.53, 128.08, 127.09, 125.91, 125.78, 124.13, 124.02, 122.71, 122.66, 122.54, 121.82, 121.57, 120.46, 119.51, 118.76, 108.75, 72.60, 70.59, 65.78, 43.17, 29.74, 29.49,20.40, 29.00, 27.30, 26.16. LR-MS(FAB) calculated C₆₀H₅₄Br₂N₂O: m/z=978.89. Found: m/z=978.

### EXAMPLE 7

N-(4-((6-((9-benzyl-9H-carbazol-3-yl)methoxy)hexyloxy)methyl)phenyl)-N-phenylbenzenamine (7b): A mixture of 7a (1.2 g, 4.17 mmol) and NaH (0.367 g, 15.29 mmol) in dry tetrahydrofuran (THF) was refluxed under Argon for 2 h. Soon TPA-C6Br (2.2 g, 5.02 mmol) in dry THF was added in one portion and reflux for 48 h. After removing the solvent, the reaction residue was partitioned between water and CH₂Cl₂ phases; after separating the water layer, the organic phase was washed with NH₄Cl for three times and dried over MgSO₄. Removed the solvent and purified the crude product by column chromatography packed with silica gel eluting with the mixture of hexane and ethyl acetate (2:1 by volume) to afford the desired product (yield: 1.97 g, 73%). ¹H NMR (400 MHz, CDCl₃): δ (ppm) 8.15 (d, 2H), 7.34 (m, 24H), 5.49 (s, 2H), 4.66 (s, 2H), 4.41 (s, 2H), 3.49 (m, 4H), 1.62 (m, 4H), 1.41 (m, 4H). LR-MS (FAB) calculated C₄₅H₄₄N₂O₂: m/z=644.84. Found: m/z=644.

### EXAMPLE 8

N-(4-((6-((9H-carbazol-3-yl)methoxy)hexyloxy)methyl)phenyl)-N-phenylbenzenamine (7c): 7b (0.5 g, 0.775 mmol) in dimethyl solfoxide (DMSO) 35 mL was cooled down to 0° C. and treated with tBuOK (0.87 g, 7.75 mmol) under oxygen overnight. After removing the solvent, the reaction residues were partitioned between water and CH₂Cl₂ phases; after separating the water layer, the organic phase was washed with NH₄Cl for three times and dried over MgSO₄. Removed the solvent and purified the crude product by column chromatography packed with silica gel eluting with the mixture of hexane and ethyl acetate (1:1 by volume) to afford the desired product (yield: 0.37 g, 85%). ¹H NMR (400 MHz, CDCl₃): δ (ppm) 8.03 (d, 2H), 7.38 (m, 3H), 7.23 (m, 8H), 6.97 (m, 8H), 4.64 (s, 2H), 4.39 (s, 2H), 3.47 (m, 4H), 1.61 (m, 4H), 1.27 (M, 4H). LR-MS (FAB) calculated C₃₈H₃₈N₂O₂: m/z=554.29. Found: m/z=554.

### EXAMPLE 9

N-(4-((6-((9-6-bromohexyl)-9H-carbazol-3-yl)methoxy)hexyloxy)methyl)phenyl)-N-phenylbenzenamine (7d): A mixture of 7c (0.5 g, 0.90 mmol) and NaH (0.08 g, 3.33 mmol) in dry THF was refluxed under Argon for 2 h. Soon, dibromohexane (0.659 g, 2.70 mmol) in dry THF was added in one portion and refluxed for 48 h. After removing the solvent, the reaction residues were partitioned between water and CH₂Cl₂ phases; after separating the water layer, the organic phase was washed with NH₄Cl for three times and dried over MgSO₄. Removed the solvent and purified the crude product by column chromatography packed with silica gel eluting with the mixture of hexane and ethyl acetate (3:1 by volume) to afford the desired product (yield: 0.452 g, 70%). ¹H NMR (400 MHz, CDCl₃): δ (ppm) 8.06 (m, 2H), 7.44 (m, 2H), 7.41 (t, 2H), 7.23 (m, 8H), 7.05 (m, 7H), 4.66 (s, 2H), 4.41 (s, 2H), 4.29 (t, 2H), 3.49 (m, 4H), 3.34 (t, 2H), 1.88 (m, 2H), 1.79 (m, 2H), 1.61 (m, 4H), 1.38 (m, 8H). LR-MS (FAB) calculated C₄₄H₄₉BrN₂O₂: m/z=717.78. Found: m/z=717.

### EXAMPLE 10

FirpicOCzOTPA (7e): A mixture of FirpicOH (405 mg, 0.570 mmol), N-(4-((6-((9-(6-bromohexyl)-9H-carbazol-3-yl)methoxyl)nethyl)phenyl)-N-phenylbenzenaime (7d) (410 mg, 0.571 mmol), Cs₂CO₃ (223 mg, 0.684 mmol) and dry acetone (50 mL) was deoxygenated and then heated to reflux temperature under argon for 24 h. The mixture was then cooled down to room temperature, evaporated in vacuum to remove the solvent and re-dissolved in CH₂Cl₂. The organic phase was washed with water, dried over MgSO₄, filtered, and evaporated to yield the crude product, which was then applied by column chromatography on silica gel, eluting with CH₂Cl₂ and hexane to yield the desired product (yield: 0.398 g, 70%). ¹H NMR (400 MHz, CDCl₃): δ (ppm) 8.76 (d, 1H), 8.20 (dd, 2H), 8.04 (m, 2H), 7.71 (m, 2H), 7.35 (m, 6H), 7.24 (m, 8H), 7.16 (td, 1H), 7.05 (m, 6H), 6.98 (td, 2H), 6.96 (td, 1H), 6.40 (m, 2H), 5.77 (dd, 1H), 5.50 (dd, 1H), 4.64 (s, 2H), 4.40 (s, 2H), 4.29 (t, 2H), 4.00 (m, 2H), 3.48 (m, 4H), 1.86 (m, 4H), 1.63 (m, 10H), 1.54 (m, 2H). LR-MS (FAB) calculated C₇₂H₆₄F₄IrN₅O₅: m/z=1347.45. Found: m/z=1347. Anal. Calcd. C, 64.17; H, 4.79; N, 5.20. Found: C, 63.43; H, 4.98; N, 5.27.

### EXAMPLE 11

### General Procedure of Polymerization for Polymers by the Yamamoto Coupling Reaction, Taking Cz-TPA-sPF as an Example.

Into a reactor, bis(1,5-cyclooctadiene) nickel (0) (Ni(COD)₂) (0.438 g, 1.59 mmol), 2,2-bipyridyl (BPY) (0.249 g, 1.59 mmol), 1,5-cyclooctadiene (COD) (0.172 g, 1.59 mmol) and anhydrous DMF (3.75 mL) were added in a glove box with nitrogen. This mixture was stirred at 90° C. for 30 min to form active catalyst. The monomer prepared in Example 5 (500 mg) and 2 (384 mg) in 11.25 mL of anhydrous toluene was added to the mixture. The polymerization proceeded at 85° C. for 2 days in the glove box, and then 1-bromo-4-tert-butylbenzene (TBP, from Sigma-Aldrich) as end-capping agent (16.5 μL) was added and allowed the mixture to react for 24 h more. The resulting polymer was purified by alumina oxide chromatography, precipitated in acetone/methanol (volume ratio=1:1) and finally dried under vacuum for 24 h to obtain the polymer. ¹H NMR (400 MHz, CDCl₃): δ 8.07 (m, 2H), 7.68 (m, 5H), 7.52 (m, 4H), 7.39 (m, 5H), 7.24 (m, 3H), 7.06 (m, 23H), 6.77 (m, 5H), 6.26 (m, 1H), 4.22 (m, 1H), 3.74 (m, 1H), 2.55 (m, 8H), 1.80 (m, 2H), 1.54 (m, 18H), 1.41 (m, 14H), 1.37 (m, 6H), 0.93 (m, 11H). The content of monomer 1 is around 47% by mole. Anal. Calcd. N, 2.78; C, 88.90; H, 7.26. Found: N, 2.63; C, 88.55; H, 7.19

Yield of TPA-Cz-sPF: 52%. ¹H NMR (400 MHz, CDCl₃): δ 7.96 (m, 2H), 7.71 (m, 9H), 7.29 (m, 2H), 7.18 (m, 7H), 7.02 (m, 7H), 6.96 (m, 7H), 6.83 (m, 4H), 6.58 (m, 1H), 6.18 (m, 1H), 4.38 (m, 2H), 4.15 (m, 4H), 3.65 (m, 2H),3.42 (m, 2H), 1.77 (m,4H),1.19 (m,30H), 0.807 (m, 6H). The content of monomer 3 is around 48% by mole. Anal. Calcd. N, 2.81; C, 87.68; H, 7.366. Found: N, 2.88; C, 87.83; H, 3.10.

Yield of 25 G-sPF: 40%. ¹H NMR (400 MHz, CDCl₃): δ (ppm) 7.85 (br), 7.68-7.65 (br), 7.59-7.58 (br), 7.48-7.41 (br), 7.28-7.24 (br), 7.18-7.16 (br), 7.04-7.02 (br), 7.02-6.95 (br), 6.94-6.77 (br), 6.73 (br), 6.65-6.55 (br), 6.19-6.16 (br), 4.38 (s), 4.14 (br), 3.67 (br), 3.47-3.34 (br), 1.84-1.58 (br), 1.50-1.47 (br), 1.30-1.14 (br), 0.96-0.86 (br), 0.77-0.72 (br). Anal. Calcd. C, 88.87; H, 6.85; N, 1.30 Found: C, 88.10; H, 6.63; N, 1.12.

Yield of 50 G-sPF: 66%. ¹H NMR (400 MHz, CDCl₃): δ (ppm) 7.85 (br), 7.68-7.65 (br), 7.59-7.58 (br), 7.48-7.41 (br), 7.28-7.24 (br), 7.18-7.16 (br), 7.04-7.02 (br), 7.02-6.95 (br), 6.94-6.77 (br), 6.73 (br), 6.65-6.55 (br), 6.19-6.16 (br), 4.38 (s), 4.14 (br), 3.67 (br), 3.47-3.34 (br), 1.84-1.58 (br), 1.50-1.47 (br), 1.30-1.14 (br), 0.96-0.86 (br), 0.77-0.72 (br). Anal. Calcd. C, 88.39; H, 6.86; N, 2.22 Found: C, 88.29; H, 6.75; N, 2.71.

Yield of 75 G-sPF: 48%. ¹H NMR (400 MHz, CDCl₃): δ (ppm) 7.85 (br), 7.68-7.65 (br), 7.59-7.58 (br), 7.48-7.41 (br), 7.28-7.24 (br), 7.18-7.16 (br), 7.04-7.02 (br), 7.02-6.95 (br), 6.94-6.77 (br), 6.73 (br), 6.65-6.55 (br), 6.19-6.16 (br), 4.38 (s), 4.14 (br), 3.67 (br), 3.47-3.34 (br), 1.84-1.58 (br), 1.50-1.47 (br), 1.30-1.14 (br), 0.96-0.86 (br), 0.77-0.72 (br). Anal. Calcd. C, 88.16; H, 6.74; N, 2.90 Found: C, 87.54; H, 6.67; N, 2.40.

Yield of 100 G-sPF: 30%. ¹H NMR (400 MHz, CDCl₃): δ 7.92 (d, 1H), 7.80 (d, 1H), 7.60 (d, 2H), 7.55 (d, 2H), 7.47 (dd, 2H), 7.39 (dd, 1H), 7.38 (d, 1H), 7.23 (m, 13H), 7.14 (td, 2H), 7.04 (td, 6H), 6.97 (tt, 2H), 4.41 (s, 2H), 4.22 (t, 2H), 3.45 (t, 2H), 1.84 (m, 2H), 1.56 (m, 2H), 1.31 (m, 12H). Anal. Calcd. C, 87.77; H, 6.87; N, 3.41 Found: C, 87.36; H, 6.68; N, 3.09.

### EXAMPLE 12

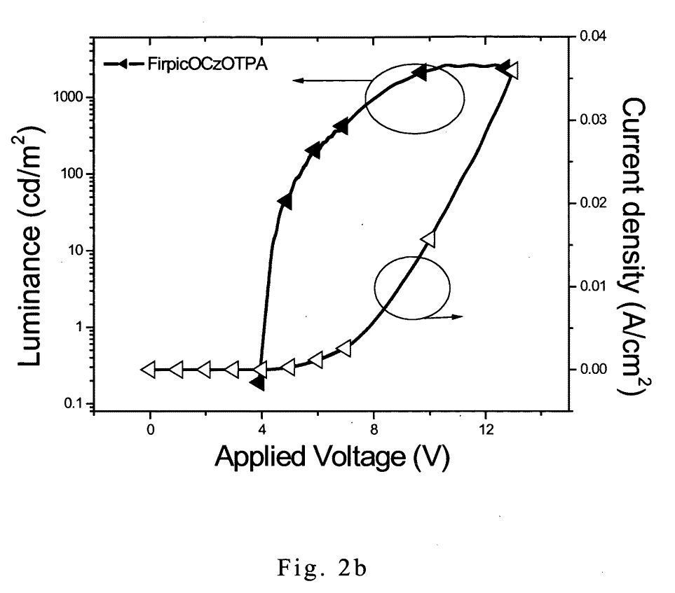

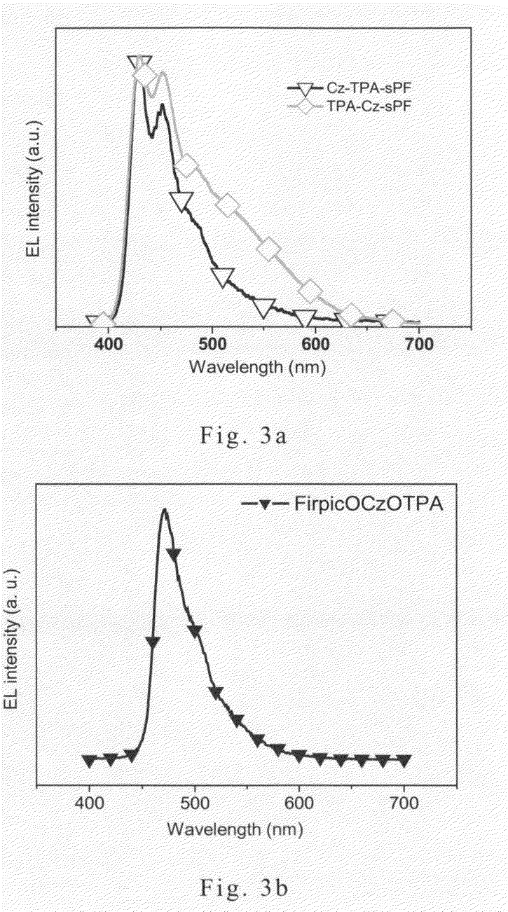

Device fabrication and characterization. An indium-tin oxide (ITO) glass plate was exposed on oxygen plasma at a power of 45 W for 5 minutes. A thin hole injection layer (25 nm) of poly(styrene sulfonic acid) doped-DEPOT (for polymer and iridium complex, Baytron PVP. AI 4083 and CH8000 from Bayer are used, respectively) was spin-coated on the treated ITO. On top of it, a thin layer (ca. 100 nm) of emitting layer was spin-cast from its solution. For polymers, the solution has a concentration of 8 mg/mL in the mixed solvent, tetrahydrofuran (THF):chlorobenzene=3:1 in volume ratio. For iridium complex, polymer mixture (PVK: OXD-7: Ir complex (63:30:7 in wt %)) was spin-cast from its solution (9 mg/mL) in chlorobenzene. Finally, a thin layer of CsF (about 1.5 nm), a thin layer of Ca (about 1.5 nm) and a layer of aluminium (ca. 70 nm) for bipolar device were deposited sequentially in a vacuum thermal evaporator through a shadow mask at a pressure of less than 10⁻⁶ Torr. The active area of the device is about 12 mm². FIG. 2a and FIG. 2b are plots showing the relationship between current density-voltage-brightness of LEDs based on conjugated polymer and iridium complex in the present invention, ITO/PEDOT/emitting layer/CsF/Ca/Al, prepared above. The LED devices emit blue light after being subjected to a positive bias and their electroluminescent (EL) spectra are shown in FIG. 3a and FIG. 3b. These LED devices have turn-on voltage about 2.8-3.9 V, the maximum efficiencies are about 4-10%, and maximum brightness of 2000-22,000 cd/m².

Although the present invention has been described with reference to specific details of certain embodiments thereof, it is not intended that such details should be regarded as limitations upon the scope of the invention except as and to the extent that they are included in the accompanying claims. Many modifications and variations are possible in light of the above disclosure.

1. An electroluminescent material grafted with multiple charge transport moieties with graded ionization potential or electrophilic property.

2. The electroluminescent material of claim 1 which is a conjugated polymer grafted with said multiple charge transport moieties.

3. The electroluminescent material of claim 2, wherein said conjugated polymer has a backbone comprising one or more repeating unit selected from the group consisting of mono-, bicycle- and polycyclic aromatic groups; heterocyclic aromatic group; substituted aromatic group; and substituted heterocyclic group.

4. The electroluminescent material of claim 3, wherein said conjugated polymer further comprises a side chain comprising a phosphorescent moiety.

5. The electroluminescent material of claim 3, wherein one of said multiple charge transport moieties is covalently linked to the backbone through a spacer selected from the group consisting of an alkylene, alkylene containing heteroatoms, substituted alkylene, substituted alkylene containing heteroatoms, aromatic group, heterocyclic aromatic group, substituted aromatic group, substituted heterocyclic aromatic group, and a combination thereof.

6. The electroluminescent material of claim 1, wherein said charge transport moieties are hole transport moieties, wherein said hole transport moieties are independently selected from the group consisting of a tertiary arylamine, a quarternary arylammonium salt, a tertiary heterocyclic aromatic amine, a quarternary heterocyclic aromatic ammonium, a substituted tertiary arylamine, a substituted quarternary arylammonium salt, a substituted heterocyclic aromatic amine, and a substituted quarternary heterocyclic aromatic ammonium.

7. The electroluminescent material of claim 1, wherein said charge transport moieties are electron transport moieties, wherein said electron transport moieties independently comprise an oxadiazole, thiodiazole, triazole, pyridine, or pyrimidine group and are independently selected from the group consisting of a monoheterocyclic aromatic group, biheterocyclic aromatic group and polyheterocyclic aromatic group.

8. The electroluminescent material of claim 3, wherein said conjugated polymer is a random copolymer, block copolymer or alternating copolymer.

9. The electroluminescent material of claim 3, wherein said conjugated polymer is a homopolymer.

10. The electroluminescent material of claim 8, wherein said conjugated polymer comprises a non-conjugated sector among two or more conjugated sectors in a backbone of said copolymer.

11. The electroluminescent material of claim 3, wherein said backbone of said conjugated polymer comprises a repeating unit of fluorene or benzene.

12. The electroluminescent material of claim 3, wherein said charge transport moieties are hole transport moieties, said backbone of said conjugated polymer comprises two different repeating units, each of which comprises a side chain, each side chain comprising a hole transport moiety, wherein said two hole transport moieties are different.

13. The electroluminescent material of claim 3, wherein said charge transport moieties are electron transport moieties, said backbone of said conjugated polymer comprises two different repeating units, each of which comprises a side chain, each side chain comprising an electron transport moiety, wherein said two electron transport moieties are different.

14. The electroluminescent material of claim 12, wherein said two different hole transport moieties are carbazole and triphenylamine.

15. The electroluminescent material of claim 13, wherein said two different electron transport moieties are oxadiazole and starburst oxadiazole.

16. The electroluminescent material of claim 5, wherein said spacer comprises hexylene or decylene.

17. The electroluminescent material of claim 3, wherein repeating units containing the multiple charge transport moieties range from 0.05 to 100 mol % in the backbone of the polymer.

18. The electroluminescent material of claim 3, wherein repeating units containing the multiple charge transport moieties range from 70 to 100 mol % in the backbone of the polymer.

19. The electroluminescent material of claim 3, wherein said conjugated polymer further comprises a crosslinkable function group.

20. The electroluminescent material of claim 3, wherein said conjugated polymer further comprises a side chain comprising a fluorescent group, and said fluorescent group is diphenylamino-di(styryl)arylene) or bis(diphenyl)aminostyryl benzene.

21. The electroluminescent material of claim 1 which is a phosphorescent organometallic complex grafted with said multiple charge transport moieties.

22. The electroluminescent material of claim 21, wherein said organometallic complex is grafted with a side chain comprising said multiple charge transport moieties.

23. The electroluminescent material of claim 22, wherein said side chain further comprises a spacer linking every two adjacent charge transport moieties of said multiple charge transport moieties.

24. The electroluminescent material of claim 23, wherein said side chain further comprises another spacer connecting said linked multiple charge transport moieties to said organometallic complex.

25. The electroluminescent material of claim 23, wherein said side chain comprises two charge transport moieties, and said two charge transport moieties are both hole transport moieties or both electron transport moieties.

26. The electroluminescent material of claim 21, wherein said organometallic complex is an Ir—, Pt—, Os— or Rb-complex, and said organometallic complex comprises an element of O, N, S, P, Cl, Br, or C, and a heterocyclic ring, which coordinates Ir, Pt, Os or Rb.

27. The electroluminescent material of claim 21, wherein said organometallic complex is an Ir—, or Pt-complex.

28. The electroluminescent material of claim 26, wherein said heterocyclic ring is 2-phenylpyridine, 2-benzo[4,5-α]thienylpyridine, (4,6-difluoro)phenylpyridine, 2-phenylbenzothiolate, acetylacetonate, or picolinate.

29. The electroluminescent material of claim 23, wherein said spacer is selected from the group consisting of an alkylene, alkylene containing heteroatoms, substituted alkylene, substituted alkylene containing heteroatoms, aromatic group, heterocyclic aromatic group, substituted aromatic group, substituted heterocyclic aromatic group, and a combination thereof.

30. The electroluminescent material of claim 24, wherein said another spacer is selected from the group consisting of an alkylene, alkylene containing heteroatoms, substituted alkylene, substituted alkylene containing heteroatoms, aromatic group, heterocyclic aromatic group, substituted aromatic group, substituted heterocyclic aromatic group, and a combination thereof.

31. The electroluminescent material of claim 29, wherein said spacer comprises hexylene.

32. The electroluminescent material of claim 30, wherein said another spacer comprises hexylene.

33. An organic light emitting diode, which comprises: a positive electrode formed on a substrate; a negative electrode; and a light emitting layer disposed between said positive electrode and said negative electrode, wherein said light emitting layer comprises an electroluminescent material grafted with multiple charge transport moieties with graded ionization potential or electrophilic property.

34. The organic light emitting diode as claimed in claim 33 further comprising an electron transporting layer formed between said light emitting layer and said negative electrode.

35. The organic light emitting diode as claimed in claim 33 further comprising a hole transporting layer formed between said positive electrode and said light emitting layer.

36. The organic light emitting diode as claimed in claim 33, which emits red light, yellow light, green light, blue light, white light or light with broad band containing multiple color peaks.
